(19) United States
(12) Patent Application Publication
(10) Pub. No.: US 2014/0013373 A1
(43) Pub. Date: Jan. 9, 2014

(54) INTERACTIVE SERVICE SYSTEM, INTERACTIVE SYSTEM AND INTERACTIVE METHOD THEREOF

(71) Applicants: Keith Huang, Hong Kong (CN); Chit Rex Ching, Hong Kong (CN); Tsz Kit Chan, Hong Kong (CN); Felix To, Hong Kong (CN); Wesley Ng, Hong Kong (CN); Pui Chi Chan, Hong Kong (CN)

(72) Inventors: Keith Huang, Hong Kong (CN); Chit Rex Ching, Hong Kong (CN); Tsz Kit Chan, Hong Kong (CN); Felix To, Hong Kong (CN); Wesley Ng, Hong Kong (CN); Pui Chi Chan, Hong Kong (CN)

(73) Assignee: STARBUCKS (HK) LIMITED, Hong Kong (CN)

(21) Appl. No.: 13/978,137

(22) PCT Filed: Dec. 31, 2011
(86) PCT No.: PCT/CN2011/085217

§ 371 Date: Sep. 25, 2013

Related U.S. Application Data
(60) Provisional application No. 61/429,314, filed on Jan. 3, 2011.

(30) Foreign Application Priority Data
Dec. 31, 2011 (CN) 201110459174.0

(51) Int. Cl. H04N 21/61

(52) U.S. Cl. CPC H04N 21/6175
USPC 725/111; 725/116

(57) ABSTRACT

An interactive system includes a server system, a modem, and a terminal device. The server system provides service content that may include a video stream and selection items. The modem connects to the server system via a network. The modem can transmit information according to priority levels. The terminal device connects to the modem. The terminal device is configured to assign a highest transmission priority level to a selection result of a selected item selected by a user from the selection items. The server system is configured to provide response information according to the selection result and transmit the response information in a unicast manner.

### CROSS-REFERENCE TO RELATED APPLICATION

The present application is based on, and claims priority from, U.S. Provisional Patent Application Ser. No. 61/429,314 and Taiwan Application Serial Number 100145828, filed on Dec. 12, 2011, the disclosure of which is hereby incorporated by reference herein in its entirety.

### BACKGROUND

1. Technical Field

The present invention relates to an interactive server system and an interactive system, and an interaction method for the interactive server system or the interactive system.

2. Related Art

Television broadcast systems have been in existence for decades. In a typical television broadcast system, television stations broadcast video streams to numerous users. The broadcast video streams can be delivered using a ground-based or satellite-based radio frequency transmission system, or via cable networks directly connecting transmitters and users.

In computing networks and communications, there is a communication method called the packet switching method. The packet switching method splits data into a plurality of packets before the data is transmitted. The transmitter assigns each packet the destination address of a receiver and sends the packets to a network. Finally, the receiver receives and combines all received packets. During the transmission of packets, packets may temporarily stay in intermediate nodes. After an intermediate node collects sufficient packets, it will send the packets to a next node. The packet switching method can simultaneously provide a plurality of sources for information transmission. Each packet can find its own preferred route to the destination. All packets are then recombined at the destination to form the complete original message. The packet switching method has advantages of high throughput, low delay, and no need to resend the entire message if one packet is lost.

In recent years, with the development of high speed packet switching data network, an Internet Protocol television (IPTV) system has been introduced. In an IPTV system, video, audio and data signals are distributed to the client ends via the internet. IPTV content is usually provided through a DSL (digital subscriber line) network or an FTTH (Fiber to the Home) optical network by the network owner, usually the local telephone company. Taking a small IPTV system as an example, the IPTV needs three network components: an encoder for converting television signals into IP data packets, a network for connecting the client ends and the service providers, and STBs (set up boxes) held at the client ends and configured for converting the IP data packets back to the television signals. A typical network may further comprise several auxiliary systems: a VOD (video on demand) server, an interstitial advertisement system, a billing system, and a DRM (digital rights management) system.

An IPTV system may use all information channels provided by the network connecting to the client ends, wherein the information channels may comprise broadcast channels and VOD channels. The IPTV systems are feasible due to the utilization of an advanced media encoding and decoding technique, resulting in high compression ratio. The media encoding and decoding technique is MPEG-4 (H.264) technology that can achieve a compression ratio of greater than 100:1. However, even with such high compression ratios, the IPTV services continue to consume the largest amount of network bandwidth. One hour of IPTV service needs 5 gigabytes of capacity, comparable to the bandwidth consumed by 1000 hours of audio data. With the increasing numbers of IPTV clients, the bandwidth requirements increase accordingly, and such trends are challenging the limits of network transmission capacity.

Program content may be transmitted using the unicast technology. Every time a new user joins the IPTV system, servers must reserve bandwidth for transmitting the content that the user requests. Accordingly, the IPTV system adopting the unicast technology needs greater bandwidth as the system serves more users. Thus, the IPTV system adopting the unicast technology has high cost per user. Although the IPTV systems adopting the unicast technology are limited by the maximum number of users that can be served simultaneously and their service costs, with the current market emphasis on customized services, the IPTV systems have a major advantage in that they can provide customized VOD services.

In order to serve multiple clients simultaneously, IPTV providers may adopt the multicast technology to transmit program content. Multicast groups use IP addresses ranging from 224.0.0.0 to 239.255.255.25 (called Class D). A media server uses Class D IP addresses to deliver a single stream to a plurality of client ends, and the client ends do not exclusively connect to the media server. However, with multicasting, VOD services cannot be provided because the client end does not exclusively connect to the media server, which prevents interactive client-server connection.

In an IPTV system, game shows are a popular type of program. In one type of game show, contestants attempt to be the first to answer questions to win a prize. Interactive game shows allow the player to input his or her answer through an STB. Next, an indication that can verify whether the answer is stored in a game server is shown on the TV screen. The game server stores all answers submitted by each player and uses this information to determine the winner If one player inputs a correct answer while the answer cannot be stored in the game server, or if there is a delay in storing the answer in the game server due to transmission difficulty or delay, the player may lose the opportunity to win. Such a situation is likely to occur when too many clients simultaneously use the IPTV system. This can lead to customer complaints that may result in the loss of money and reputation of game show providers.

### SUMMARY

One embodiment discloses an interactive system comprising a server system, a modem, and a terminal device. The server system may be configured to provide service content. The service content may comprise a video stream and selection items. The modem may connect to the server system via a network. The modem is configured to transmit information according to priority levels. The terminal device may connect to the modem. The terminal device may be configured to assign the highest transmission priority level to a selection result of a selected item selected by a user from the selection items.

Another embodiment discloses an interactive server system. The interactive server system may be configured to provide service content that may comprise a video stream and selection items, receive a selection result that is provided according to the selection items and transmitted at a highest transmission priority level, and generate response information when receiving the selection result.

One embodiment discloses an interaction method for an interactive system. The method comprises providing service content comprising a video stream and selection items, receiving a selection result provided according to the selection items by a user, and assigning a highest transmission priority level to the selection result.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1 schematically illustrates an interactive system according to one embodiment;

FIG. 2 illustrates a flow diagram related to the interactive system according to one embodiment;

FIG. 3 schematically illustrates a media streaming server according to one embodiment;

FIG. 4 illustrates a flow diagram showing an instantly responsive interaction method for an interactive system;

FIG. 5 schematically demonstrates the hardware structure of a terminal device according to one embodiment;

FIG. 6 illustrates a functional block diagram of a terminal device according to one embodiment;

FIG. 7 schematically demonstrates the overlaying of the graphic element onto the images according to one embodiment;

FIG. 8 schematically demonstrates the hardware of a modem according to one embodiment;

FIG. 9 schematically illustrates the function of a modem according to one embodiment; and

FIG. 10 schematically illustrates an interactive system according to another embodiment.

### DETAILED DESCRIPTION OF DISCLOSED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One embodiment provides an interactive system comprising a server system configured to provide, via a network, service content to a user, who provides, based on the service content, a selection assigned with a high transmission priority level, for example the highest transmission priority level. The selection is transmitted to the server system, which stores the selection and immediately provides an indicator on the selected item of the service content to verify to the user that his selection is successfully stored.

In one embodiment, the server system provides service content comprising, but not limited to, a game program, a game, an opinion poll, or an auction service.

The user may use a terminal device that may be a video streaming device to connect to the server system. In one embodiment, the terminal device may comprise, but is not limited to, a set top box.

The user may use an input device to make a selection from the service content. The input device may comprise a remote controller, a touch screen, a keyboard, an electronic mouse, or the like.

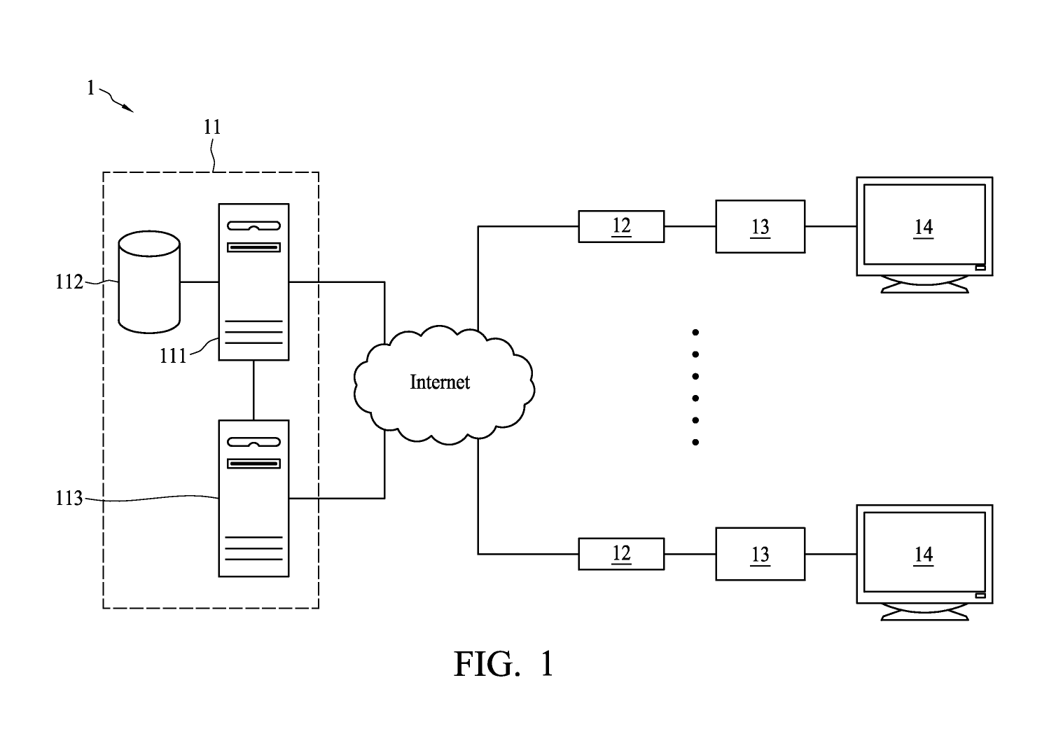

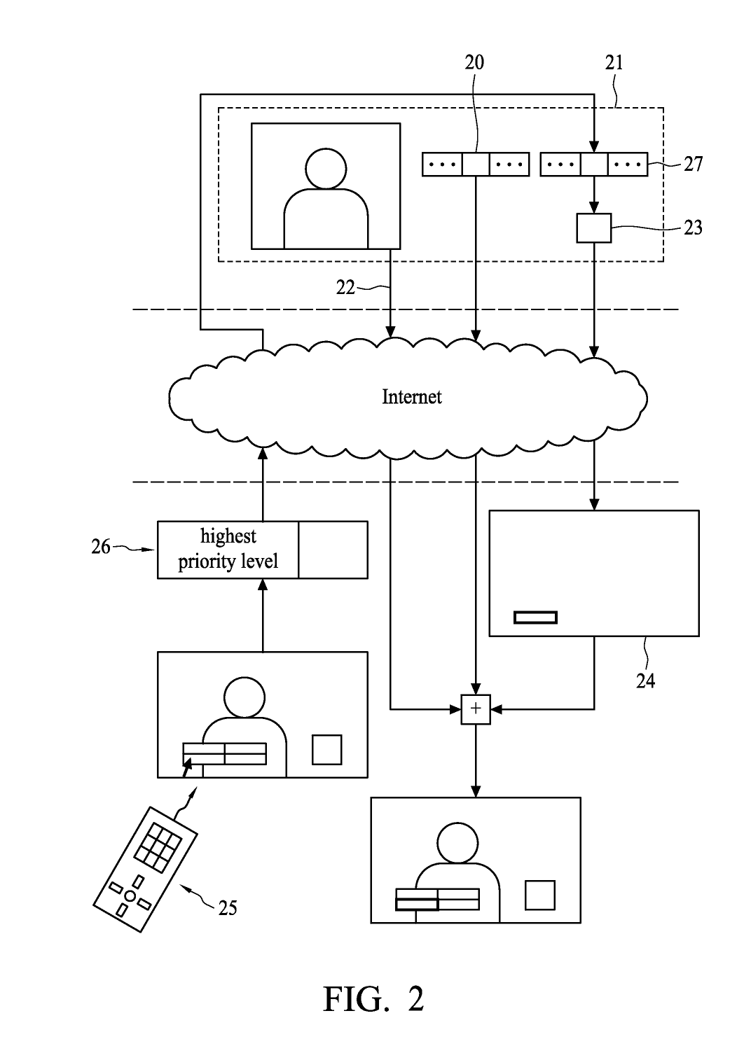

FIG. 1 schematically illustrates an interactive system 1 according to one embodiment. FIG. 2 illustrates a flow diagram related to the interactive system 1 according to one embodiment. Referring to FIGS. 1 and 2, the interactive system 1 may be an IPTV system and may comprise a server system 11 configured to connect to a network. The server system 11 may comprise service content 21 that may comprise a video stream 22 and selection items 20. The server system 11 may be designed to provide program services by broadcasting. A plurality of client ends connect to the network. Each client end may comprise a modem 12, a terminal device 13, and a display 14. Each client end connects to the server system 11 via the modem 12 to receive video, audio and data streaming information from the server system 11, and to transmit information to the server system 11. The terminal device 13 connects to the display 14 and the modem 12. The terminal device 13 is configured to display the video, audio and data streaming signals on the display 14.

The network may be an Internet Protocol network, a public IP network, or a combination thereof The network may comprise a wired network or a wireless network. The wireless network may be a WiFi network and/or 3G or LTE mobile telecommunication network.

The server system 11 may comprise a media streaming server 111 and a database 112. The media streaming server 111 may connect to the network, and may be configured to provide the client ends with information or to receive information from the client ends. The database 112 may connect to the media streaming server 111, and may be configured to store information relevant to the clients.

The server system 11 may further comprise at least one server 113 that may comprise a VOD server, an interstitial advertisement system, a billing system, a DRM system, an accounting server, or an authorization server. In addition, the server system 11 may also comprise the server included in the present IPTV system or sub-systems thereof.

The display 14 connecting to the terminal device 13 may comprise a television screen, a computer monitor, a projector or other device that can display images.

Referring to FIGS. 1 and 2, the interactive system 1 can be configured for, but is not limited to, a quiz or game show. As such, the service content 21 may comprise selection items 20 comprising questions provided for users and answer items. The terminal device 13 can decode the video stream 22 to provide image data. The selection items 20 can be unicast information. The terminal device 13 may overlay the image data with the selection items 20 so that the image data and the selection items 20 can be simultaneously displayed on the display 14.

The user can use a remote controller 25 to make a selection of the selection items 20 on the display 14. After the terminal device 13 receives a selection result made by the user from the selection items 20, the selection result may be converted into a standard internet transmission format, encapsulated into suitable information format 26 such as packets or frames, and assigned with a priority level.

After the server system 11 receives the selection result from the modem 12, the selection result is stored and linked to a client object 27 corresponding to the user, and response information 23 is generated accordingly. The response information 23 may comprise information used to generate a graphic element 24, which is configured to allow the user to confirm that his answer has been received by the server system 11. The response information 23 can be unicast information. The terminal device 13 may generate the graphic element 24 according to the response information 23. The image data and the graphic element 24 are overlapped and displayed on the display 14.

In one embodiment, the response information 23 may further comprise the username of the user and/or the total or average score information.

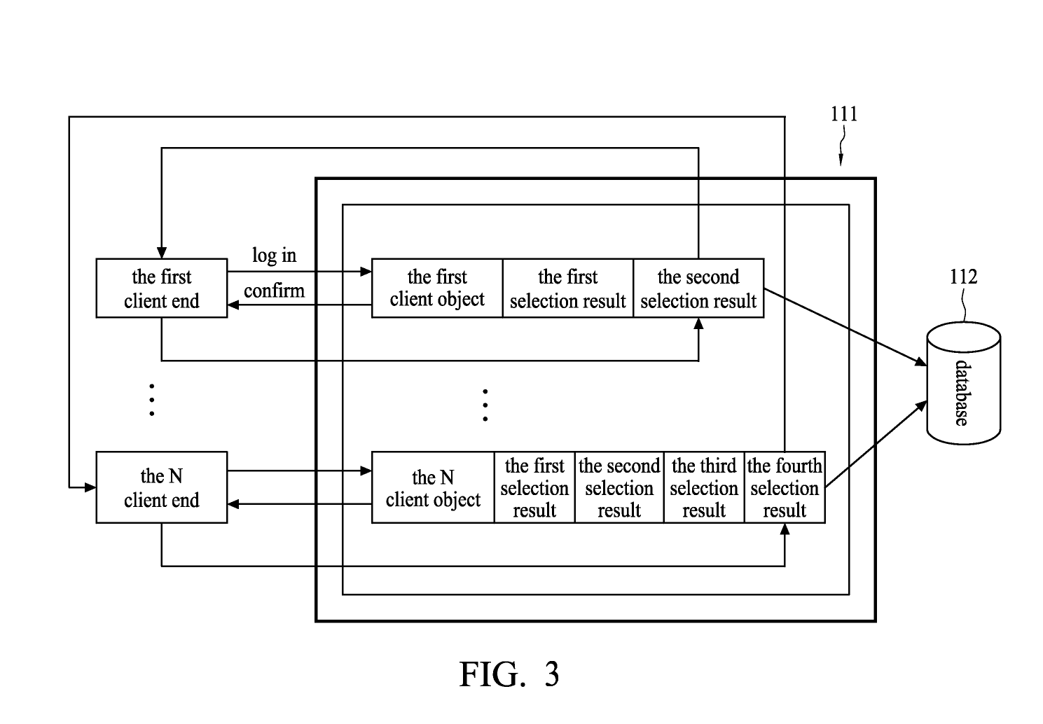

FIG. 3 schematically illustrates a media streaming server 111 according to one embodiment. As shown in FIG. 3, a user wishing to receive services must log in to the media streaming server 111 before receiving services. For example, after the user at a first client end logs in to the media streaming server 111, the media streaming server 111 may generate a corresponding first client object, and send a confirmation signal to the corresponding client end. Each of client objects (the first client object to the N client object) may comprise the username or code of the corresponding user, or other information related to the user.

Referring to FIG. 3, after the user at the first client end inputs a second selection result, the second selection result is transmitted immediately to the media streaming server 111 and is linked to the corresponding first client object. The media streaming server 111 can determine the score of the user by evaluating the selection results linked to the first client object.

In one embodiment, the media streaming server 111 may comprise a volatile memory, and the first to N client objects and the selection results are all stored in the volatile memory in order to allow the system 1 to respond more quickly.

Referring to FIG. 3 again, the media streaming server 111 may connect to a database 112. The first to N client objects and the selection results may also be stored in the database 112 for backup purposes. As such, the first to N client objects and the selection results may be protected from being lost accidentally.

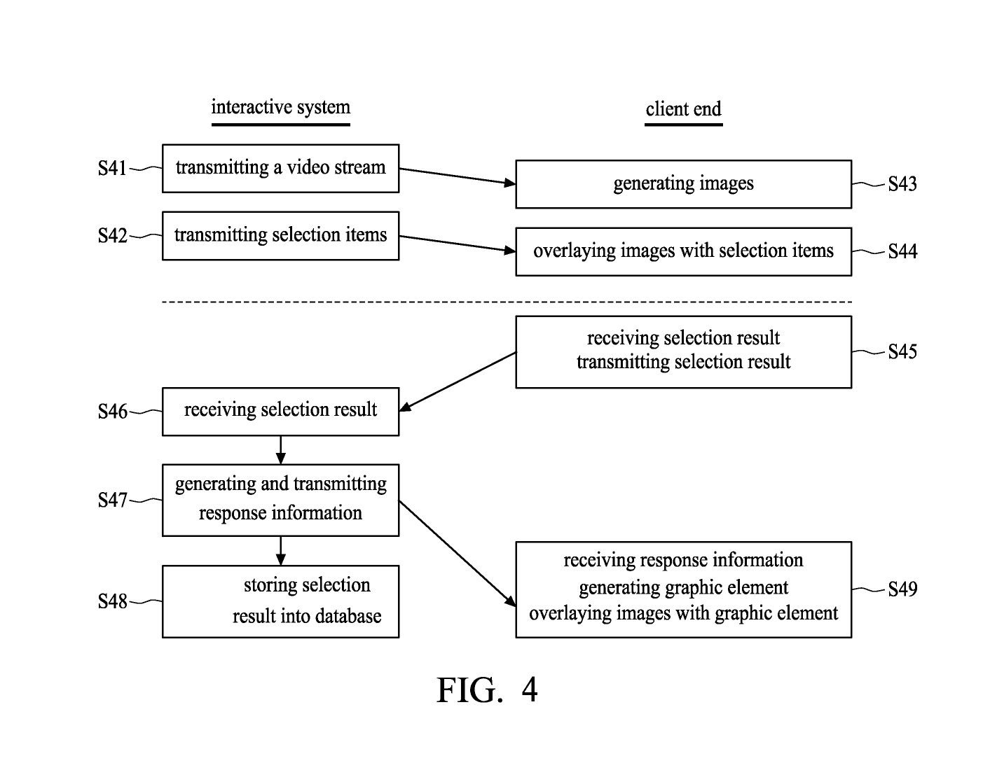

FIG. 4 illustrates a flow diagram showing an instantly responsive interaction method for an interactive system. Referring to FIG. 4, the interaction method initially transmits a video stream and selection items to the terminal device of a client end (Steps S41 and S42) by the interactive system. Next, the terminal device of the client end converts the video stream into display images (Step S43), overlays the images with the selection items, and displays the images and the selection items on the display (Step S44). Next, the terminal device receives a selection result from the user, assigns the selection result with the highest transmission priority level, and transmits the selection result (Step S45). The interactive system receives the selection result and stores the selection result in a memory (Step S46). Next, the interactive system generates response information, which is then sent to the terminal device of the client end (Step S47). The interactive system links the selection result to a corresponding client object, and then stores the selection result into a database (Step S48). The terminal device receives the response information, generates a graphic element according to the response information, and lays the graphic element onto the images generated from the video stream so as to produce new service content, wherein the new service content comprises display content that is configured for the confirmation of the acceptance of the selection result by the server system (Step S49).

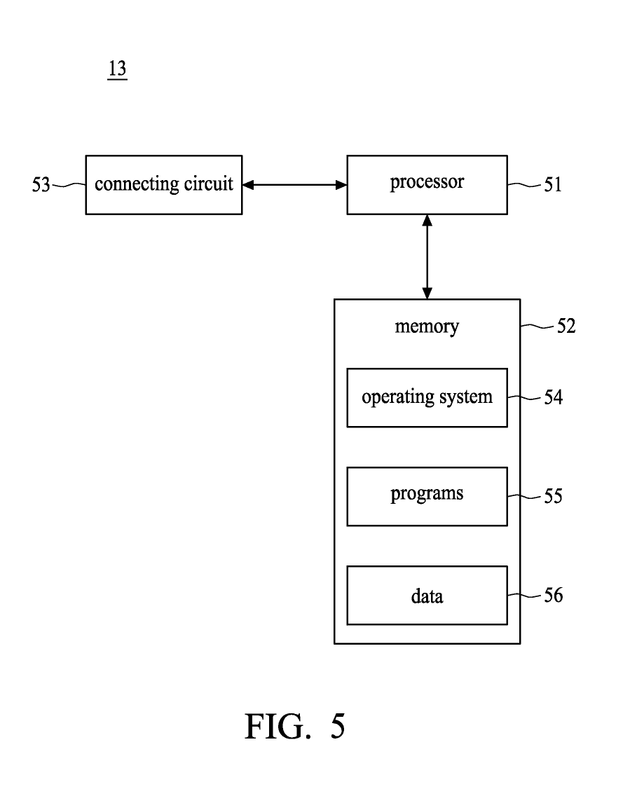

FIG. 5 schematically demonstrates the hardware structure of a terminal device 13 according to one embodiment. Referring to FIG. 5, the terminal device 13 comprises a processor 51, a memory 52, and a connecting circuit 53.

The memory 52 can store an operating system 54, programs 55, and data 56. The operating system 54 is configured to control the hardware, peripheral devices, files, and resource arrangement. The programs 55 are used to allow the terminal device 13 to perform the required functions. The data 56 comprises the necessary information for the operation of the terminal device 13. The connecting circuit 53 is configured to connect to external devices, such as a modem or a display screen. The processor 51 is configured to run programs. The memory 52 may comprise a volatile memory device or a non-volatile memory device.

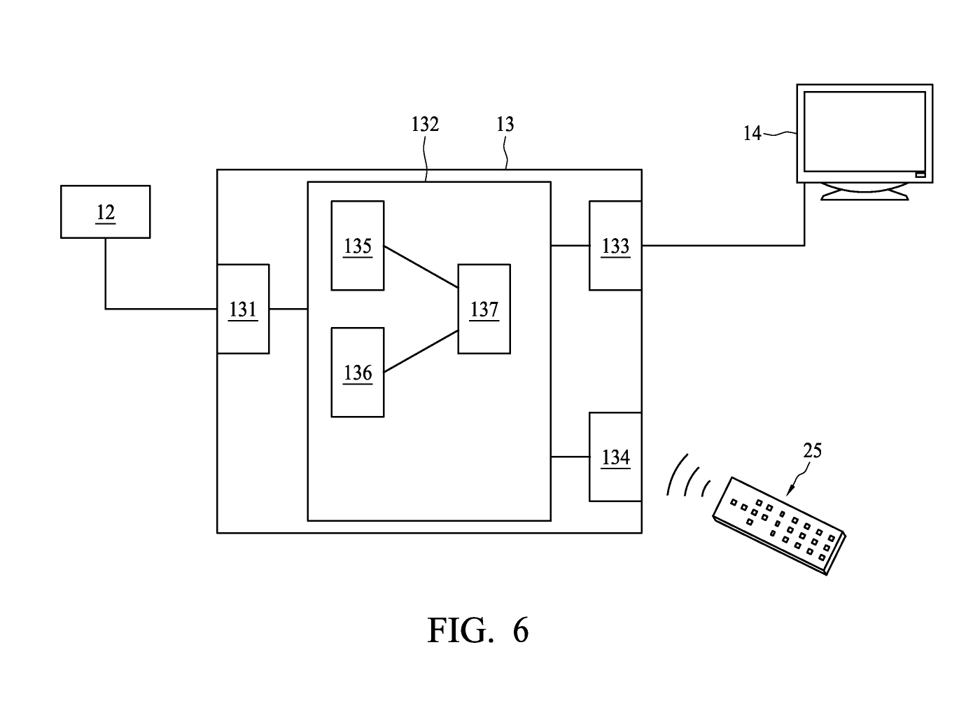

FIG. 6 illustrates a functional block diagram of a terminal device 13 according to one embodiment. As shown in FIG. 6, the network interface 131 receives a video stream, response information, and selection items. The selection result is also transmitted to the modem 12 via the network interface 131. The video stream is transmitted to a video streaming decoder 135, which decodes the video stream to generate image data that is then provided to an overlay engine 137. Response information is provided to a graphic element generator 136 to generate a graphic element, which is also provided to the overlay engine 137.

In the overlay engine 137, the graphic element is laid onto the image data from the video streaming decoder 135. The resultant image data is output by the processor to the display interface 133 and from there is provided to the display 14 for viewing by the user.

The terminal device 13 can be controlled using a remote controller 25. The remote control interface 134 receives signals generated by the user pushing a button and accordingly a selection result is generated and then passed to the processor 132 where the selection result is encapsulated into an appropriate data format (i.e. data packets). The data packets are assigned with the highest transmission priority level and output to the network interface 131 and from there are sent to the modem 12.

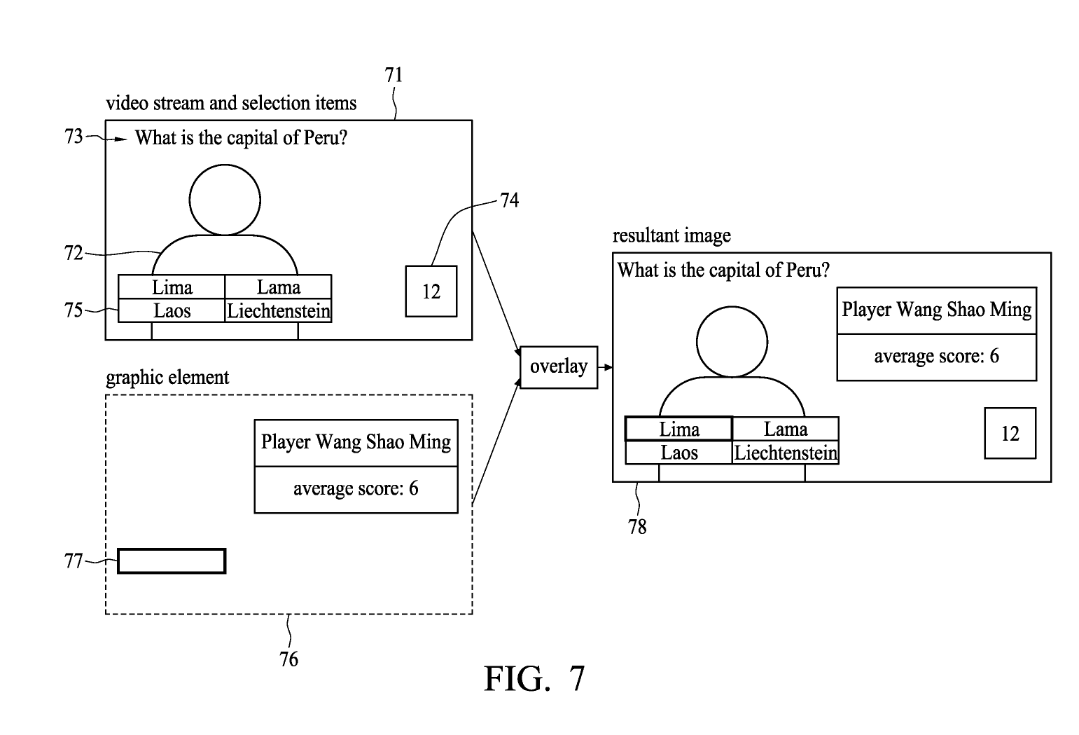

FIG. 7 schematically demonstrates the overlaying of the graphic element onto the images according to one embodiment. In the example of FIG. 7, after a video stream is decoded, images 71 are shown on the display. The images 71 may comprise the image of a host 72. The interactive system 1 provides selection items, which are laid onto the image 71 as shown in FIG. 7. In the present embodiment, a question 73 (“What is the capital of Peru?”) is shown above the host 72. In the bottom right of the image 71, a timer 74 indicates the time left for an answer to be given. In the present embodiment, the value 12 is shown inside a frame to indicate that 12 seconds are left to answer. In the bottom of the image 71, a table 75 is presented which contains multiple choice answers (the choices provided are “Lima,” “Lama,” “Laos” and “Liechtenstein”) to the question 73 presented in a 2×2 grid format.

The image 76 is an example of a graphic element 24. Some personal details of the user can be presented on the image 76, for example, the username (Wang Shao Ming) of the user and the user's average score (“6”). In addition, the user has chosen an answer (corresponding to the top left answer, “Lima”), and therefore a highlighting box 77 is provided to acknowledge the selection.

The terminal device 13 is configured to overlay the images 71 with the image 76, and the result is shown by image 78. In the image 78, the highlighting box 77 is laid over the answer “Lima” to acknowledge the selection. Moreover, the personals details can also be seen on the image 78.

In the present embodiment, the highlighting box 77 is used to demonstrate how to acknowledge the selection of the user; however, the present invention is not limited to such means. Other means that can allow the user to acknowledge his selection are applicable in the embodiments of the present invention.

In particular, each user can see only his personal details and his selection shown on the images from the video stream, and cannot see other users' personal details and selection. The users who do not log in only can see only the images generated from the video stream.

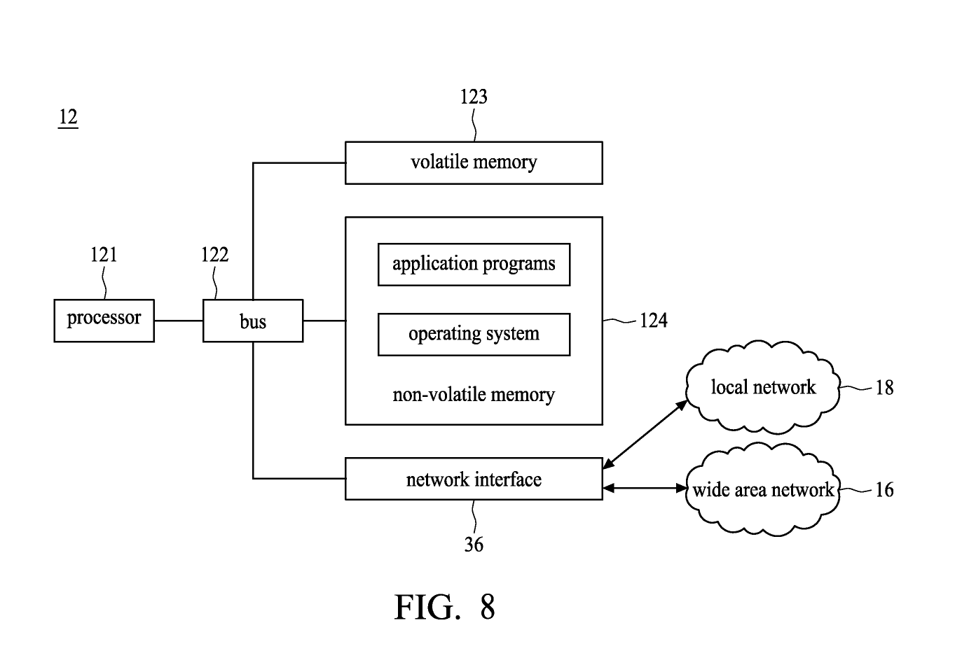

FIG. 8 schematically demonstrates the hardware of a modem according to one embodiment. Referring to FIG. 8, the modem 12 may comprise a processor 121, a bus 122, a volatile memory 123, a non-volatile memory 124, and a network interface 36. The processor 121, the volatile memory 123, the non-volatile memory 124, and the network interface 36 are all connected to the bus 122. The modem 12 may further comprise application programs and an operation system all configured for its operation. The application programs and the operation system may be stored in the non-volatile memory 124. When the modem 12 is turned on, the application programs and the operation system are loaded onto the volatile memory 123. The network interface 36 is configured to connect to a local network 18 or a wide area network 16.

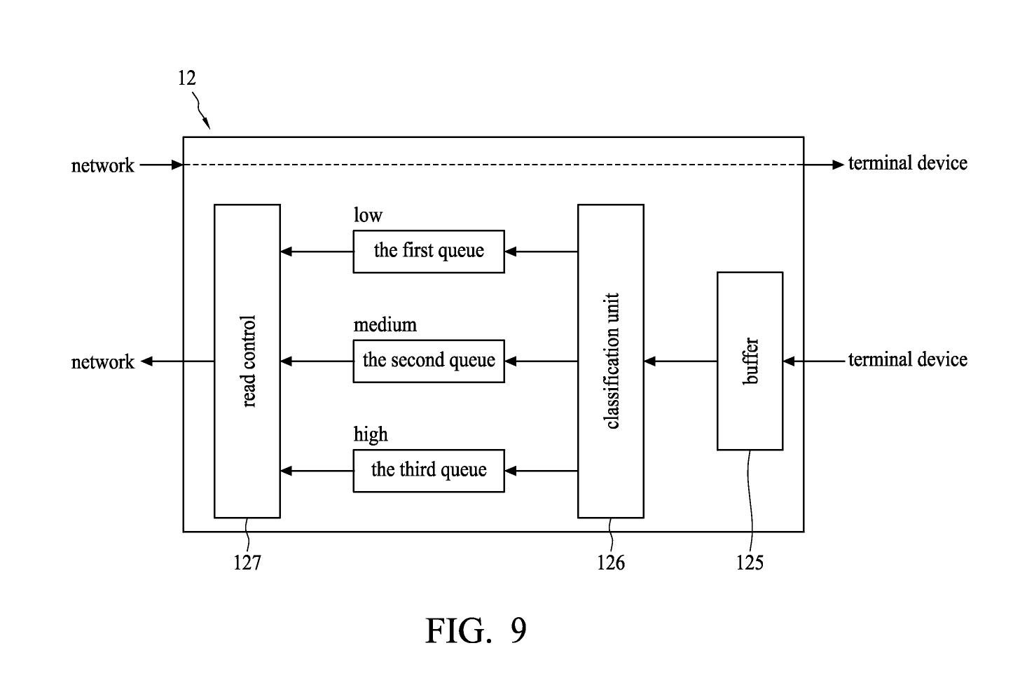

FIG. 9 schematically illustrates the functional diagram of a modem according to one embodiment. The interactive system 1 disclosed in the embodiments is configured to ensure that the selection of the user is quickly stored in the media streaming server 111 and quickly shown on the display to allow the user to verify that his selection has been accepted. As such, unnecessary troubles can be avoided. To this end, in the interactive system 1, the flows of information on the network are classified for traffic regulation. The selection answer will be sent to the media streaming server 111 with high priority so that the answer can be quickly accepted. Transmission delay or the situation where the media streaming server 111 does not receive the answer can be avoided. The management of the flow of the interactive system 1 can use many protocols, such as Type of Service (TOS), Quality of Service (QoS) 802.1 Q and 802.1p, or the like.

In one embodiment, the terminal device 13 encapsulates the selection answer into a frame tagged with the highest priority so that the frame can be sent precedentially.

In one embodiment, the traffic flow regulation of the network of the interactive system 1 can depend on the setting of IP precedence values which determine the priority of frames to be sent.

Referring to FIG. 9, the modem 12 comprises a buffer 125, a classification unit 126, first to third queues, and a read control 127. The buffer 125 connects to the terminal device 13, configured for temporarily storing packets or frames from the terminal device 13. The classification unit 126 connects to the buffer 125 and the first to third queues, configured to dispatch packets or frames to the suitable queues in accordance with the transmission priority of the packets or frames. In the example of the modem 12, the first queue is configured for packets or frames with low priority, the second queue is configured for packets or frames with medium priority, and the third queue is configured for packets or frames with high priority. The above-mentioned configuration is illustrated; however the present invention is not limited to such configuration. The first to third queues connect to the read control 127 that is configured to transmit the packets or frames being queued in the first to third queues in sequence to the network.

In the present embodiment, the modem 12 is configured to transmit, in the upstream direction or from a direction from the terminal device 13 to the network, packets classified as having three priority levels while to transmit, from the upstream direction or the network to the terminal device 13, non-priority packets or frames. However, the present invention is not limited to such a configuration.

Several examples are illustrated to explain the details of the packet flow control related to the interactive system 1.

In one embodiment, in the upstream direction or the direction from the terminal device 13 to the network, the frames with 802.1p priority field assigned with 5 (802.1p=5) are classified into the third, high priority, queue for transmission. The frames with 802.1p priority field assigned with 3 (802.1p=3) are classified into the second, medium priority, queue. The frames with 802.1p priority field assigned with 0, 1, 2, 4, 6, and 7 (802.1p=0, 1, 2, 4, 6, and 7) are classified into the first, low priority, queue.

In the untagged frames, the frames with IP precedence value of 5 are classified into the third, high priority, queue for transmission. The frames with IP precedence value of 3 are classified into the second, medium priority, queue. The frames with IP precedence value of 0, 1, 2, 4, 6, and 7 are classified into the first, low priority, queue.

In another embodiment, the frames can be converted into the frame with VID (VLAN identifier). The IP precedence values of the frames are written in the 802.1p field. The frames with IP precedence value of 5 are classified into the third, high priority, queue. The frames with IP precedence value of 3 are classified into the second, medium priority, queue. The frames with IP precedence value of 0, 1, 2, 4, 6, and 7 are classified into the first, low priority, queue.

In the upstream direction, from the terminal device 13 to the network, the frames with a priority level assigned with 5 (802.1p=5) are classified into the third, high priority, queue for transmission. The frames with a priority level assigned with 3 (802.1p=3) are classified into the second, medium priority, queue. The frames with a priority level assigned with 0, 1, 2, 4, 6, and 7 (802.1p=0, 1, 2, 4, 6, and 7) are classified into the first, low priority, queue.

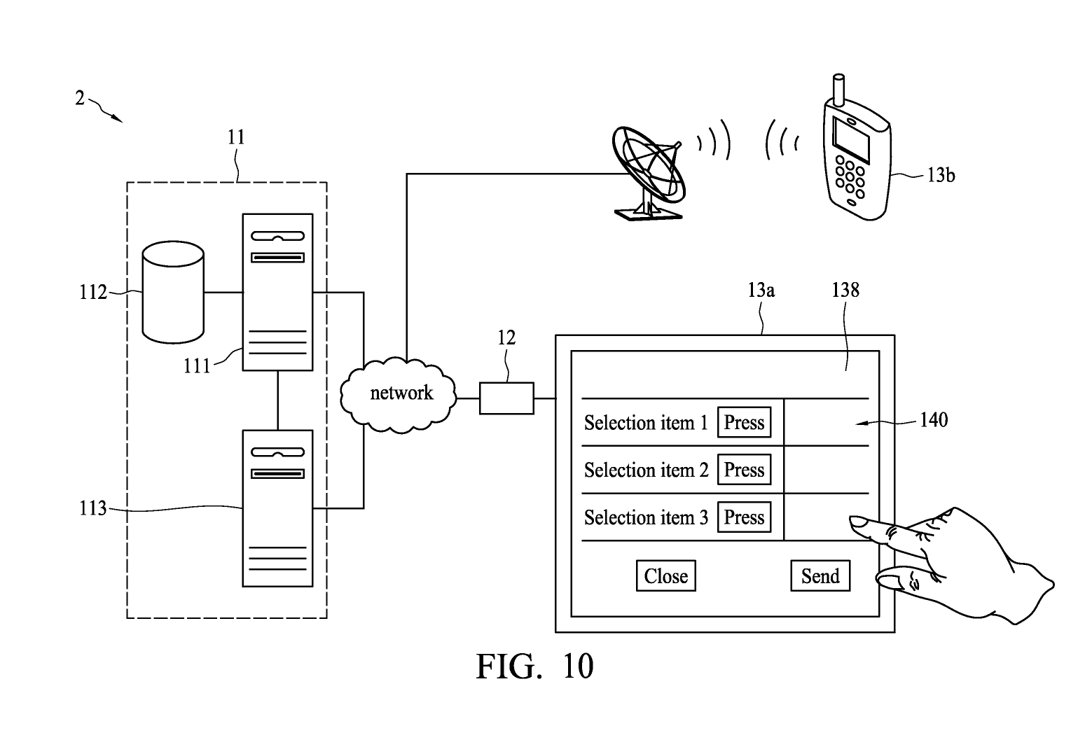

FIG. 10 schematically illustrates an interactive system 2 according to another embodiment. As shown in FIG. 10, the terminal device 13a connects to the internet via the modem 12. The server system 11 provides service content to the terminal device 13a and a wireless terminal device 13b via the internet. The displays of the terminal device 13a and the wireless terminal device 13b display the service content for users. The service content can be transmitted using a video streaming method. The service content can be an opinion poll, an auction service, etc. The service content comprises selection items 140. The terminal device 13a may comprise a touch screen 138 where a user can input a desired selection item 140. The terminal device 13a can assign a selection result with the highest transmission priority level for transmission. The modem 12 is configured to transmit data according to its priority level. After the server system 11 receives the selection result, it stores the selection result and generates response information according to the selection result. In one embodiment, the server system 11 may assign the packets encapsulated from response information with the highest transmission priority level so that the packets can be transmitted back to the terminal device 13a as quickly as possible. In another embodiment, the server system 11 may transmit the response information back to the terminal device 13a in a unicast manner. After the terminal device 13a receives the response information, the selected item will be highlighted so that the user can make sure that his selection is accepted by the server system 11. The selection result is transmitted by the highest transmission priority level and response information is transmitted back quickly such that the interaction between the server system 11 and users may be almost in real time.

It will be apparent to those skilled in the art that various modifications and variations can be made to the disclosed embodiments. It is intended that the specification and examples be considered as exemplary only, with a true scope of the disclosure being indicated by the following claims and their equivalent.

What is claimed is:

1. An interactive system comprising:
a server system configured to provide service content comprising a video stream and selection items;
a modem connecting to the server system via a network, configured to transmit information according to priority levels; and
a terminal device coupling to the modem, configured to assign a highest transmission priority level to a selection result of a selected item selected by a user from the selection items.

2. The interactive system of claim 1, wherein the server system is configured to generate response information according to the selection result and transmit the response information to the terminal device in a unicast manner.

3. The interactive system of claim 2, wherein the terminal device is configured to generate a graphic element according to the response information and lay the graphic element over the selected item.

4. The interactive system of claim 1, wherein the server system is configured to generate a client object when the user logs in, wherein the selection result is linked to the client object.

5. The interactive system of claim 4, wherein the server system is configured to receive a new selection result and link the new selection result to the client object.

6. The interactive system of claim 5, wherein the server system comprises a database comprising the client object and the selection results.

7. The interactive system of claim 1, wherein the service content comprises a game program, a game, an opinion poll, or an auction service.

8. An interactive server system configured to provide service content comprising a video stream and selection items, receive a selection result that is provided according to the selection items and transmitted at a highest transmission priority level, and generate response information when receiving the selection result.

9. The interactive server system of claim 8, configured to transmit the response information in a unicast manner.

10. The interactive server system of claim 9, further comprising a terminal device configured to generate a graphic element according to the response information and to lay the graphic element over a selected item.

11. The interactive server system of claim 8, configured to generate, when a user logs in, a client object linking to the selection result.

12. The interactive server system of claim 11, configured to receive a new selection result and link the new selection result to the client object.

13. The interactive server system of claim 11, further comprising a database comprising the selection results and the client object.

14. The interactive server system of claim 11, wherein the service content comprises a game program, a game, an opinion poll, or an auction service.

15. An interaction method for an interactive system, comprising the steps of:
providing service content comprising a video stream and selection items;
receiving a selection result provided according to the selection items by a user; and
assigning a highest transmission priority level to the selection result.

16. The interaction method of claim 15, further comprising a step of transmitting response information in a unicast manner after receiving the selection result.

17. The interaction method of claim 16, further comprising a step of generating a graphic element according to the response information and laying the graphic element over a selected item.

18. The interaction method of claim 15, further comprising a step of generating a client object when the user logs in.

19. The interaction method of claim 15, further comprising a step of linking the selection result to the client object.
